(19) United States
(12) Patent Application Publication
(10) Pub. No.: US 2014/0158622 A1
(43) Pub. Date: Jun. 12, 2014

(54) RECOVERY METHOD AND DRAW SOLUTION FOR FORWARD OSMOSIS

(71) Applicant: Samsung Electronics Co., Ltd., Suwon-Si (KR)

(72) Inventors: Satoshi YANASE, Yokohama (JP); Kenji KONO, Yokohama (JP); Nagahisa SATO, Yokohama (JP)

(73) Assignee: Samsung Electronics Co., Ltd., Suwon-Si (KR)

(21) Appl. No.: 14/100,606

(22) Filed: Dec. 9, 2013

(30) Foreign Application Priority Data
Dec. 7, 2012 (JP) 2012-268685
Nov. 1, 2013 (KR) 10-2013-0132347

(51) Int. Cl. C02F 1/44

(52) U.S. Cl. CPC C02F 1/445
USPC 210/644; 252/180; 252/181

(57) ABSTRACT

The present disclosure relates to a water recovery method and an FO draw solution that reduce the energy consumption required for water recovery, increase the osmotic pressure of a draw solution, recover the water from a DS mixed solution relatively easily, and reduce a solute that remains in the water, and simultaneously reduce fouling of the FO membrane. The water recovery method may include inflowing water into a draw solution by partitioning a feed solution including water and a draw solution, including a basic temperature-sensitive polymer and an acidic gas dissolved therein and having higher osmotic pressure than the feed solution, with a forward osmosis membrane.

### CROSS-REFERENCE TO RELATED APPLICATIONS

This application claims priority under 35 U.S.C. §119 to Japanese Patent Application No. 2012-268685, filed on Dec. 7, 2012, and Korean Patent Application No. 10-2013-0132347, filed in the Korean Intellectual Property Office on Nov. 1, 2013, the entire contents of which are incorporated herein by reference.

### BACKGROUND

1. Field

This disclosure relates to a water recovery method and a draw solution for forward osmosis.

2. Description of the Related Art

A water recovery technology of an FO (forward osmosis) method has been considered to lessen energy consumption required for water recovery compared with a water recovery technology of an RO (reverse osmosis) method. Accordingly, in recent times, developments of a water recovery technology of an FO method have been actively made. Herein, the water recovery process by an FO method includes partitioning a feed solution (a solution that is subject to water recovery) and a draw solution having a higher osmotic pressure than the feed solution with a forward osmotic membrane, then inflowing water of the feed solution into the draw solution, and recovering water from the mixed draw solution including the water and the draw solution. The draw solution may be referred to as DS. Energy consumption required for water recovery may be a sum of energy put into a system, for example, to process water recovery. In the FO method, because water moves spontaneously from a feed solution to a draw solution (unlike in an RO method), it is not necessary to apply pressure to the feed solution. Accordingly, the water recovery technology by an FO method may lessen energy consumption for water recovery compared with the water recovery technology by an RO method. While water recovery technology by an FO method has been developed, the developments are broadly classified into FO membrane development and draw solution development. For developing the draw solution, the main themes include 1) providing the draw solution with a relatively high osmotic pressure, and 2) recovering water from the DS mixed solution. Either theme has objectives for reducing the energy consumption required for water recovery.

In this regard, a first technique may involve using a solution in which carbon dioxide and ammonia are dissolved in a relatively high concentration as a draw solution. The draw solution has a relatively high osmotic pressure. In addition, the first technique may remove a solute of carbon dioxide and ammonia from the DS mixed solution by heating the DS mixed solution, so water may be recovered from the DS mixed solution.

A second technique may involve using a polymer solution as a draw solution. The second technique recovers water from the DS mixed solution by recovering the polymer dissolved in the DS mixed solution by ultrafiltration. According to the second technique, water is recovered by the relatively simple treatment of ultrafiltration, which suggests decreasing the energy consumption required for water recovery.

A third technique may involve using a solution having a low critical solution temperature as a draw solution. The draw solution is used to precipitate a solute of a polymer when heated to a temperature of greater than or equal to a low critical solution temperature. The polymer refers to a temperature-sensitive polymer. The third technique is used to precipitate a solute of a temperature-sensitive polymer and to coagulate the same by heating the DS mixed solution (i.e., to be phase-separated from the DS mixed solution). Further, according to the third technique, water is recovered from the DS mixed solution by recovering the coagulated temperature-sensitive polymer by nanofiltration (NF).

However, according to the first technique, a relatively large amount of energy is required to reuse carbon dioxide and ammonia which are removed from the draw solution. In other words, the amount of energy for removing the solute from the DS mixed solution is relatively small, but the amount of energy for recovering and reusing the solute is relatively large so the energy consumption required for water recovery is still relatively high. The method also has a problem in that the recovered water is not suitable for drinking because of the possibility of ammonia remaining in the recovered water.

According to the second technique, while a polymer is used as a solute of the draw solution, it is relatively difficult for the draw solution using the polymer as a solute to have high osmotic pressure which is an important characteristic required for the draw solution. That is, it is known that the osmotic pressure of the draw solution depends on the molar concentration of the solute. On the other hand, the polymer has a high molecular weight which is mass per mole. Because of this, a relatively large amount of polymer is required to be dissolved in the draw solution (i.e., to increase the mass percent concentration of the polymer) in order to increase the molar concentration of the polymer. In addition, the second technique has a problem in that the polymer may be incompletely removed from the DS mixed solution by only using the ultrafiltration since a relatively large amount of polymer is dissolved in the draw solution. Also, it has another problem of easily plugging (fouling) the ultrafiltration membrane. Because of this, the second technique may not accomplish the objects of reducing the energy consumption required for water recovery.

The third technique also uses a polymer as a solute of the draw solution, so it has a problem of difficulty of providing the draw solution with high osmotic pressure. In addition, as a relatively large amount of polymer is dissolved in the DS mixed solution, a relatively large amount of polymer is still dissolved in the DS mixed solution even if the polymer is precipitated and coagulated from the DS mixed solution. Because of this, since the DS mixed solution still has a relatively high osmotic pressure, it is required to apply a higher pressure than the osmotic pressure of the DS mixed solution in order to perform nanofiltration with the DS mixed solution. Accordingly, the third technique also has a problem of increasing the energy consumption required for water recovery. In addition, when the mass percent concentration of the polymer is relatively high in the DS mixed solution, the fouling phenomenon significantly occurs when performing nanofiltration, thus causing a problem of deteriorating permeability of the nanofiltration (NF) membrane by the fouling. The permeability deterioration becomes a relatively large barrier for recovering water. This problem occurs regardless of whether the polymer is coagulated or not.

### SUMMARY

The present disclosure provides a water recovery method and FO draw solution that reduce the energy consumption required for water recovery, increase the osmotic pressure of a draw solution, recover the water from a DS mixed solution more easily, and reduce a solute that remains in the water, and simultaneously reduce the fouling of an FO membrane.

According to some example embodiments of the present disclosure, a water recovery method may include inflowing water into a draw solution by partitioning a feed solution and a draw solution with a forward osmosis membrane. The feed solution includes the water, and the draw solution includes a basic temperature-sensitive polymer and an acidic gas dissolved therein. The draw solution has a higher osmotic pressure than the feed solution.

The water recovery method according to the present disclosure may include inflowing water of the feed solution into the draw solution by partitioning the feed solution and the draw solution having higher osmotic pressure than the feed solution with a forward osmosis membrane.

The basic temperature-sensitive polymer and the acidic gas are dissolved in the draw solution.

Because the basic temperature-sensitive polymer is dissolved in the draw solution, a relatively large amount of acidic gas may be dissolved in the draw solution. Accordingly, the osmotic pressure of a draw solution may be increased with relative ease. In addition, as the temperature-sensitive polymer and acidic gas may be removed from the DS mixed solution by merely heating and filtering the DS mixed solution, water may be easily recovered from the DS mixed solution. In addition, as a relatively large amount of acidic gas may be dissolved into the draw solution, the mass percent concentration of the temperature-sensitive polymer may be reduced. Accordingly, the solute remaining in water recovered from the DS mixed solution may be reduced, and simultaneously, the fouling of an FO membrane may be reduced.

In addition, as the temperature-sensitive polymer is precipitated and coagulated by heating, the solute of the draw solution may be easily recovered and reused. Furthermore, as ammonia is not used as a solute, water recovered from the DS mixed solution is safer.

The temperature-sensitive polymer may include a functional group represented by the following Chemical Formula 1.

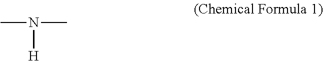

According to the present disclosure, the temperature-sensitive polymer increases an affinity for an acidic gas due to a functional group represented by Chemical Formula 1. That is, a larger amount of an acidic gas may be dissolved in a draw solution.

The temperature-sensitive polymer may be a polymer represented by the following Chemical Formula 2.

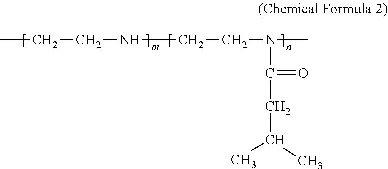

According to one example embodiment, as the temperature-sensitive polymer is a polymer represented by Chemical Formula 2, the polymer may be coagulated at a lower heating temperature. Accordingly, the energy consumption required for water recovery is reduced.

In addition, the acidic gas may include carbon dioxide.

According to the present disclosure, the acidic gas includes carbon dioxide, so that a larger amount thereof may be dissolved in the draw solution, and simultaneously, the water recovered from the DS mixed solution becomes safer.

In addition, the present disclosure may include precipitating the temperature-sensitive polymer in the DS mixed solution and simultaneously removing acidic gas from the DS mixed solution by heating the DS mixed solution (including the water and a draw solution), and separating the precipitated temperature-sensitive polymer from the DS mixed solution.

According to the present disclosure, the temperature-sensitive polymer and acidic gas may be removed with relative ease from the DS mixed solution, and simultaneously the highly pure water may be recovered.

According to another example embodiment of the present disclosure, a forward osmosis (FO) draw solution in which a basic temperature-sensitive polymer and an acidic gas are dissolved is provided.

### DETAILED DESCRIPTION

It will be understood that when an element or layer is referred to as being “on,” “connected to,” “coupled to,” or “covering” another element or layer, it may be directly on, connected to, coupled to, or covering the other element or layer or intervening elements or layers may be present. In contrast, when an element is referred to as being “directly on,” “directly connected to,” or “directly coupled to” another element or layer, there are no intervening elements or layers present. Like numbers refer to like elements throughout the specification. As used herein, the term “and/or” includes any and all combinations of one or more of the associated listed items.

It will be understood that, although the terms first, second, third, etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, e.g., “beneath,” “below,” “lower,” “above,” “upper,” and the like, may be used herein for ease of description to describe one element or feature's relationship to another element(s) or feature(s) as may have been illustrated in the figures. It will be understood that the spatially relative terms are intended to encompass different orientations of the device in use or operation in addition to the orientation that may have been depicted in the figures. For example, if the device in the figures is turned over, elements described as “below” or “beneath” other elements or features would then be oriented “above” the other elements or features. Thus, the term “below” may encompass both an orientation of above and below. The device may be otherwise oriented (rotated 90 degrees or at other orientations) and the spatially relative descriptors used herein interpreted accordingly.

The terminology used herein is for the purpose of describing various embodiments only and is not intended to be limiting of example embodiments. As used herein, the singular forms “a,” “an,” and “the” are intended to include the plural forms as well, unless the context clearly indicates otherwise. It will be further understood that the terms, “comprises,” “comprising,” “includes,” and/or “including,” if used herein, specify the presence of stated features, integers, steps, operations, elements, and/or components, but do not preclude the presence or addition of one or more other features, integers, steps, operations, elements, components, and/or groups thereof.

Example embodiments may have been described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the shapes of regions that may have been illustrated herein but are to include deviations in shapes that result, for example, from manufacturing.

Unless otherwise defined, all terms (including technical and scientific terms) used herein have the same meaning as commonly understood by one of ordinary skill in the art. It will be further understood that terms, including those defined in commonly used dictionaries, should be interpreted as having a meaning that is consistent with their meaning in the context of the relevant art and will not be interpreted in an idealized or overly formal sense unless expressly so defined herein.

In the present disclosure, the mass percent concentration of the temperature-sensitive polymer means the mass percent concentration based on the total mass of water and a temperature-sensitive polymer.

### (Water Recovery Method)

First, a water recovery method according to the present disclosure is explained.

The water recovery method may include about three steps.

The first step may include inflowing water of the feed solution into the draw solution by partitioning the feed solution and the draw solution having a higher osmotic pressure than the feed solution with a forward osmosis membrane.

Herein, a basic temperature-sensitive polymer and an acidic gas are dissolved in the draw solution.

Hereinafter, the draw solution is also referred to as “DS”.

The forward osmotic membrane is also referred to as “FO membrane”.

The second step may include precipitating the basic temperature-sensitive polymer in the DS mixed solution and simultaneously removing the acidic gas from the DS mixed solution by heating the DS mixed solution including or consisting of water and DS.

The third step may include separating the precipitated temperature-sensitive polymer from the DS mixed solution.

### (First Step)

The first step will now be explained in further detail.

As described above, the first step includes inflowing water of the feed solution into the DS by partitioning the feed solution and the DS having a higher osmotic pressure than the feed solution with a forward osmosis membrane.

In other words, in the first step, water of the feed solution is flowed into the DS according to an FO method.

In the first step, because of the osmotic pressure difference between the feed solution and the DS, water of the feed solution is spontaneously permeated through the FO membrane to be flowed into the DS. Thereby, a DS mixed solution in which water is mixed with the DS is generated.

In the FO method, in order to inflow water of the feed solution into the DS, specific energy is not required.

The feed solution may be any solution as long as it includes water. The feed solution may be, for example, water from a natural system (for example a sea, river, lake, swamp, pond, and the like, such as sea water, blackish water, river water, and the like), industrial drain water, various water drained from homes, and the like.

The DS includes a basic temperature-sensitive polymer and an acidic gas. The DS may dissolve a relatively large amount of the acidic gas due to the basic temperature-sensitive polymer. That is, while the osmotic pressure of the DS is maintained relatively high by dissolving a relatively large amount of acidic gas in the DS according to the present disclosure, the mass percent concentration of the temperature-sensitive polymer may be decreased.

The temperature-sensitive polymer has characteristics of being able to be precipitated from the DS (or a DS mixed solution) and coagulated at greater than or equal to a desired or predetermined temperature. On the other hand, when the temperature-sensitive polymer is precipitated, the DS or the DS mixed solution loses transparency (for example, is whitened). Because of this, it may be assumed that the temperature-sensitive polymer is precipitated by monitoring light transmittance deterioration of the DS or the DS mixed solution. The precipitation of the temperature-sensitive polymer may be checked even with the naked eye.

The temperature-sensitive polymer according to the present disclosure may include the following functional group represented by Chemical Formula 1 as a basic functional group. The polymer including the functional group represented by Chemical Formula 1 may include polyethylene imine. The polyethylene imine may be used as a raw material for producing the post-described Chemical Formula 2 or Chemical Formula 3.

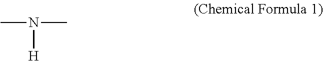

The temperature-sensitive polymer may be, for example, a polymer represented by the following Chemical Formula 2.

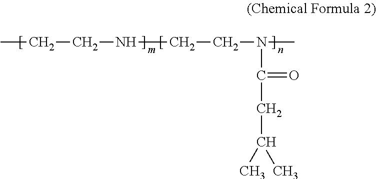

When the temperature-sensitive polymer is a polymer represented by Chemical Formula 2, the temperature-sensitive polymer may be precipitated and coagulated at a relatively low temperature of about 60° C. Thereby, the energy consumption required for water recovery is further reduced.

The temperature-sensitive polymer may specifically be a polymer represented by the following Chemical Formula 3.

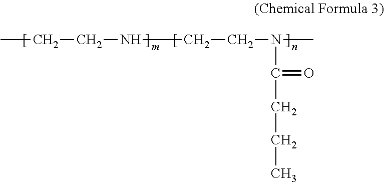

When the temperature-sensitive polymer is a polymer represented by Chemical Formula 3, the temperature-sensitive polymer may be precipitated and coagulated at a relatively low temperature of about 50° C. Thereby, the energy consumption required for water recovery is further reduced.

The temperature-sensitive polymer represented by Chemical Formula 2 or Chemical Formula 3 may be obtained by reacting a raw material of polyethylene imine with isovaleric acid or butyric anhydride. It is confirmed by the known structure determining method, for example, NMR, that the temperature-sensitive polymer has a structure of Chemical Formula 2 or Chemical Formula 3, particularly, in an n/m ratio. n and m are both integers of greater than or equal to 1.

The weight average molecular weight of polyethylene imine is not particularly limited, but may be about 600-70,000. When the weight average molecular weight is within the range, water having particularly high purity (i.e., including a small amount of remaining temperature-sensitive polymer) may be recovered from the DS mixed solution.

The weight average molecular weight of the polyethylene imine may be measured by a known measuring method, for example, chromatography.

However, when the weight average molecular weight of the polyethylene imine is less than about 600, the temperature-sensitive polymer is hardly coagulated, but the temperature-sensitive polymer may be separated from the DS mixed solution by a very fine semipermeable membrane (for example, a nanofiltration membrane, an RO membrane, and the like).

In addition, when the weight average molecular weight of polyethylene imine is greater than about 70,000, the weight average molecular weight of the temperature-sensitive polymer is also increased, so the mass percent concentration of DS is excessively increased when the required osmotic pressure is accomplished by only the temperature-sensitive polymer. However, according to the present disclosure, as a relatively large amount of acidic gas is dissolved in the DS, the osmotic pressure of the DS may be increased while the mass percent concentration of the temperature-sensitive polymer is maintained to be relatively low.

In addition, the mass percent concentration of the temperature-sensitive polymer in the DS depends on the solubility limit of the temperature-sensitive polymer, but the mass percent concentration may be about 1-30 mass %, for example, about 5-15 mass %. When the mass percent concentration of the temperature-sensitive polymer is within the range, relatively high pure water may be recovered from the DS mixed solution.

On the other hand, when the mass percent concentration of the temperature-sensitive polymer is less than about 1 mass %, the temperature-sensitive polymer may be hardly coagulated, but the temperature-sensitive polymer may be separated from the DS mixed solution by a very fine semipermeable membrane (for example, a nanofiltration membrane, an RO membrane, and the like).

In addition, even when the mass percent concentration of the polyethylene imine is more than about 30 mass %, the acidic gas partially fulfils the osmotic pressure requirement, so the mass percent concentration of the temperature-sensitive polymer may be reduced compared to the case in which only the temperature-sensitive polymer fulfils the required osmotic pressure requirement. However, according to the present disclosure, the mass percent concentration of the temperature-sensitive polymer is reduced, and a high osmotic pressure is accomplished by dissolving a large amount of the acidic gas in the DS, so the mass percent concentration of the temperature-sensitive polymer may be within the range.

In addition, the polymer represented by Chemical Formula 2 or Chemical Formula 3 is mostly a linear polymer, but may be a branched polyethylene imine having a desired or predetermined branching degree. The polymer represented by Chemical Formula 2 or Chemical Formula 3 may have a structure of a dendrimer or a hyper-branched polymer.

The acidic gas may be, for example, carbon dioxide. The acidic gas may additionally be sulfur dioxide or sulfur trioxide. The acidic gas may also be a mixture of these gases.

In the present disclosure, because the basic temperature-sensitive polymer is dissolved in the DS, a relatively large amount of the acidic gas may be dissolved in the DS. Accordingly, in the present disclosure, the osmotic pressure of the DS may be controlled by adjusting the molar concentration of the acidic gas.

That is, the molar concentration of acidic gas may be adjusted to reach the required osmotic pressure of the DS. However, the upper limit of solubility of the acidic gas depends on parameters of the temperature-sensitive polymer (i.e., weight average molecular weight, mass percent concentration), so the parameters of the temperature-sensitive polymer are adjusted to fulfill the required osmotic pressure by the acidic gas. As the osmotic pressure becomes higher, more water may be recovered from the feed solution, so the acidic gas may be dissolved in the DS until reaching the upper limit of solubility.

On the other hand, the acidic gas, which may be carbon dioxide, may be dissolved in the DS by, for example, a method of bubbling the carbon dioxide gas in the DS dissolved with the temperature-sensitive polymer, a method of adding the DS into a pressurized container and introducing the carbon dioxide gas into the container with pressure, and a method of adding the DS and dry ice into a pressure solution and allowing it to stand. Other methods may also be used.

The FO membrane is not particularly limited, but may include a known forward permeation membrane without limitation. The FO membrane may include, for example, a 3 cellulose acetate membrane manufactured by Hydration Technologies Inc. (HTI), or an RO membrane such as a 2 acetic acid and 3 acetic acid mixed cellulose acetate membrane of CE or CG manufactured by General Electric (GE) and the like may be used as the FO membrane.

On the other hand, the FO membrane may be a membrane having relatively high hydrophilicity. This is because it is more difficult for pollutants from the feed solution to be attached thereto.

### (Second Step)

The second step includes heating a DS mixed solution to precipitate a temperature-sensitive polymer in the DS mixed solution and to simultaneously remove an acidic gas from the DS mixed solution.

In other words, in the second step, the DS mixed solution is heated, and the DS mixed solution is maintained at the temperature after heating for a desired or predetermined amount of time. The optimal temperature and time for the maintaining/supporting are different depending upon the parameters of the temperature-sensitive polymer dissolved in the DS mixed solution. As described above, when the temperature-sensitive polymer is a polymer represented by Chemical Formula 2, the polymer is precipitated and coagulated at greater than or equal to about 60° C. In addition, when the temperature-sensitive polymer is a polymer represented by Chemical Formula 3, the polymer is precipitated and coagulated at greater than or equal to about 50° C.

Because of this, for example, in the DS mixed solution in which the temperature-sensitive polymer having a structure of Chemical Formula 2 is dissolved at a concentration of 5 mass %, it may induce the temperature-sensitive polymer coagulation by maintaining/supporting the same at a temperature of greater than or equal to about 60° C. for greater than or equal to about 10 minutes. However, it is recommended to maintain the desired or predetermined temperature for greater than or equal to about 1 hour to remove carbon dioxide dissolved in the DS mixed solution. In other words, in the second step, the DS mixed solution is heated to coagulate and precipitate the temperature-sensitive polymer, and the carbon dioxide acidic gas is also removed from the DS mixed solution.

### (Third Step)

The third step includes separating the precipitated temperature-sensitive polymer from the DS mixed solution.

The precipitated temperature-sensitive polymer may be separated by a membrane method, although example embodiments are not limited thereto.

Herein, the separating by the membrane method means separating the temperature-sensitive polymer by membrane filtration.

On the other hand, when the temperature of the DS mixed solution is decreased during the filtration, the temperature-sensitive polymer is dissolved in the DS mixed solution again (i.e., leaves the phase-separation state), so the membrane filtration is performed while maintaining a relatively high temperature when the DS mixed solution is returned to a transparent state.

The solute is removed from the DS mixed solution by the second and third steps.

That is, water of the feed solution is recovered from the DS mixed solution.

According to the present disclosure, water is recovered from the DS mixed solution by the very simple method of heating and membrane filtering.

The membrane used in the membrane filtration may be selected considering the molecular weight of the temperature-sensitive polymer or the coagulated state by phase-separation. That is, the precipitated temperature-sensitive polymer is coagulated in the DS mixed solution. In addition, when the coagulated temperature-sensitive polymer is present as a relatively large lump (for example, a lump having a particle diameter of larger than about 0.01 μm), a microfiltration membrane having pores with a diameter of about 10 μm to about 0.01 μm or an ultrafiltration membrane having a cutoff molecular weight of several tens of thousands to several thousands may be used.

On the other hand, when the coagulated temperature-sensitive polymer is present as a relatively small lump (for example, a lump having a particle diameter of less than or equal to about 0.01 μm), a nanofiltration (NF) membrane or a reverse osmotic (RO) membrane may be used.

The coagulated state of the temperature-sensitive polymer may be confirmed by the light transmittance being significantly deteriorated by determining whether the liquid is whitened with the naked eye or by measuring the light transmittance.

In addition, the microfiltration membrane and the ultrafiltration membrane are not particularly limited, and may include any known materials without limitation.

For example, the microfiltration membrane and the ultrafiltration membrane according to the present disclosure may include a flat sheet type of ultrafiltration membrane or a microfiltration membrane manufactured by ADVANTECH Co., Ltd., or a hollow fiber ultrafiltration membrane or microfiltration membrane manufactured by ASAHI KASEI Chemicals.

The NF membrane and the RO membrane are also not particularly limited, and may include any known materials without limitation.

The NF membrane may include, for example, NTR-7400 series of sulfonated polysulfone composite membranes, or NTR-729HF or NTR-7250 series of PVA composite membranes, manufactured by Nitto Denko, Romembra SU-610 or SU-210S series of piperazine amide-based cross-linking composite membranes manufactured by Toray, FILMTEC NF-90 or NF-70 membranes manufactured by DOW, and the like.

The RO membrane includes, for example, NTR-70SWC, Hydranautics SWC5 manufactured by Nitto Denko, Romembra SU-810 and SU-820 manufactured by Toray, FILMTEC SW30 manufactured by Dow, ES-20 and Hydranautics ESPA2 manufactured by Nitto Denko, Romembra SU-710 and SU-720 manufactured by Toray, FILMTEC BW30LE manufactured by Dow, and the like.

In addition, according to the present disclosure, the phase-separated DS mixed solution is centrifuged before the membrane filtration to separate a thick phase and a diluted phase, and then the diluted phase is taken to perform the membrane filtration. Thereby, purer water may be recovered, and fouling may be simultaneously suppressed.

When the concentration of the temperature-sensitive polymer in the DS mixed solution is not reduced by the membrane filtration after a one time pass, the DS mixed solution is re-filtered using a membrane having a lower molecular weight cutoff to recover water having a higher purity.

### EXAMPLES

Hereinafter, examples of the present disclosure are explained in further detail.

First, synthesis examples of the temperature-sensitive polymer are described.

### Synthesis Example 1

50 mL of distillated dimethylformamide (DMF) is put into a 300 mL 3-necked flask, and 11.8 g of isovaleric acid is dissolved in the DMF as a reagent for obtaining the structure of Chemical Formula 2. In addition, 15.0 g of N-hydroxy succinic imide is added to the DMF solution. Then, the DMF solution is chilled with ice, and 25.0 g of N,N′-dicyclohexyl carbodiimide is added to the DMF solution at one time, and the DMF solution is agitated for 2 hours.

Subsequently, 12 g of polyethylene imine having a weight average molecular weight of 25,000 is dissolved in 50 mL of DMF, and the DMF solution of the polyethylene imine is added to the DMF solution. In addition, 23 mL of triethylamine (TEA) is added to the DMF solution and agitated for 5 days at room temperature. Thereby, the temperature-sensitive polymer is precipitated by the DMF solution. The precipitate is then separated from the DMF solution by membrane filtration. Subsequently, the filtrate of the DMF solution is heated and removed under reduced pressure, and diethylether is added to the remains. The temperature-sensitive polymer is thereby re-precipitated in diethylether. Then, a series of operations of membrane filtrating the diethylether including re-precipitation, removing diethylether under the reduced pressure, and re-precipitating the temperature-sensitive polymer are repeated several times, so as to provide a temperature-sensitive polymer.

When the temperature-sensitive polymer is evaluated for structure with NMR, it is confirmed that the temperature-sensitive polymer has a structure represented by Chemical Formula 2. The n/m ratio is assumed to be 1.5.

### Synthesis Examples 2 to 4

A temperature-sensitive polymer is prepared in accordance with the same procedure as in Synthesis Example 1, except that the polyethylene imine has a weight average molecular weight of 600, 1800, and 70,000, respectively. All the obtained temperature-sensitive polymers are assumed to have an n/m ratio of 1.5 by measuring with NMR.

### Synthesis Example 5

A temperature-sensitive polymer is prepared in accordance with the same procedure as in Synthesis Example 1, except that isovaleric acid of Synthesis Example 1 is substituted for n-butyric anhydride.

The temperature-sensitive polymer is evaluated for structure with NMR, and it is confirmed that the temperature-sensitive polymer has a structure represented by Chemical Formula 3. In addition, the n/m ratio is estimated to be 1.5.

### Example 1

The temperature-sensitive polymer obtained from Synthesis Example 1 is dissolved in ion-exchange water to prepare a solution including 5 mass % of the temperature-sensitive polymer. 10 g of the solution is input into a pressure container with 5 g of dry ice and closely sealed and allowed to stand for 1 hour. The solution is referred to as solution A. The solution A corresponds to the DS mixed solution. In other words, in Example 1, instead of performing the first step, a solution in which the temperature-sensitive polymer and carbon dioxide are dissolved in ion-exchange water is considered as a DS mixed solution. The first step is essentially a treatment of inflowing water into the DS, so this consideration is reasonable.

The solution A is measured for osmotic pressure according to a cryoscopic method, and the result shows that it is 110 (mOsm). The solution A is heated at 60° C. for 30 minutes. Thereby, the solution A is whitened. In other words, the temperature-sensitive polymer is precipitated and coagulated by the solution A. On the other hand, carbon dioxide is removed from the solution A by the heating treatment.

Subsequently, the cloudy solution A is filtered by an ultrafiltration membrane (manufactured by ADVANTECH Co., Ltd.) having a cutoff molecular weight of 50,000 to provide a filtrate. The filtrate is referred to be as solution B. The solution B corresponds to water recovered from the DS mixed solution. The osmotic pressure of solution B is measured in accordance with the same procedure as in the solution A, and the results show that it is 10 (mOsm). The osmotic pressure ratio of the solution A and the solution B before and after filtration is 0.09.

### Examples 2 to 4

Using each synthesized temperature-sensitive polymer obtained from Synthesis Examples 2 to 4, the same operations as in Example 1 are performed, and the osmotic pressure ratio before and after the filtration is measured. The results are shown in the following Table 1.

TABLE 1

| | Osmotic pressure ratio |
|---|---|
| Example 2 | 0.46 |
| Example 3 | 0.35 |
| Example 4 | 0.11 |

### Examples 5 to 7

The same operations as in Example 1 are performed, except that the temperature-sensitive polymer in the solution A has a mass percent concentration of 1, 15, and 30 mass %, respectively, and the osmotic pressure ratio before and after the filtration is measured. The results are shown in the following Table 2.

TABLE 2

| | Osmotic pressure ratio |
|---|---|
| Example 5 | 0.20 |
| Example 6 | 0.14 |
| Example 7 | 0.22 |

### Example 8

The same procedure is performed as in Example 1 using the temperature-sensitive polymer synthesized from Synthesis Example 5. However, in Example 8, the solution A is heated at a temperature of 50° C. The osmotic pressure ratio before and after the filtration is 0.10.

### Comparative Example 1

A solution is prepared by dissolving only the temperature-sensitive polymer at 5 mass % without using dry ice of Example 1. The solution is referred to be as solution C. The solution C corresponds to a DS mixed solution.

The osmotic pressure of solution C is measured, and the result shows that it is 25 (mOsm).

### Comparative Example 2

A solution is prepared by dissolving only dry ice in the ion-exchange water without using the temperature-sensitive polymer of Example 1. In other words, 10 g of ion-exchange water and 5 g of dry ice are input into a pressure container and closely sealed and allowed to stand for 1 hour to provide the solution. The solution is referred to be as solution D. The solution D corresponds to a DS mixed solution. The osmotic pressure of solution D is measured, and the result shows that it is 44 (mOsm).

### Comparative Example 3

The transparent solution A according to Example 1 is filtered with an ultrafiltration membrane (manufactured by ADVANTECH Co., Ltd.) having a cutoff molecular weight of 50,000 without heating the same to provide a filtrate. The filtrate is referred to be as solution E.

The solution E corresponds to water recovered from the DS mixed solution. The osmotic pressure of solution E is measured and the result shows that it is 88 (mOsm), and the osmotic pressure ratio before and after the filtration is 0.73.

### Comparative Example 4

A solution including a temperature-sensitive polymer at 50 mass % is prepared by dissolving the temperature-sensitive polymer obtained from Synthesis Example 1 in ion-exchange water. The solution is referred to be as solution F.

The solution F corresponds to a DS mixed solution. A polymer which is dissolved and remains in the solution F is found.

The osmotic pressure of solution F is measured, and the result shows that it is 450 (mOsm). The solution F is filtered with an ultrafiltration membrane (manufactured by ADVANTECH Co., Ltd.) having a cutoff molecular weight of 50,000 as in Example 1, but a filtrate is not obtained.

### (Evaluation)

The solution A obtained from Example 1 has osmotic pressure of 110 (mOsm) which is higher than 70 (mOsm) which is the sum of the osmotic pressure of 25 (mOsm) of the solution C obtained from Comparative Example 1 in which dry ice is not dissolved and the osmotic pressure of 44 (mOsm) of the solution D obtained from Comparative Example 2 in which the temperature-sensitive polymer is not dissolved. Accordingly, it is proven that the temperature-sensitive polymer according to the examples may dissolve a large amount of carbon dioxide in the DS, and resultantly, the osmotic pressure of DS is increased.

In addition, the osmotic pressure ratios of Examples 1 to 8 may be within the range of 0.09-0.46.

The osmotic pressure ratio of Comparative Example 3 is 0.73.

It may be understood that the filtrate obtained from the filtration becomes closer to pure water as the osmotic pressure ratio becomes smaller.

On the other hand, in Comparative Example 4, the filtrate is not recovered from the start. It is suspected that this is because the ultrafiltration membrane undergoes fouling. Thereby, it is proved that water having high purity is recovered from the DS mixed solution according to a series of steps of the present disclosure.

In addition, it is understood that the osmotic pressure ratio is decreased when the polyethylene imine has a weight average molecular weight of 600-70,000 according to Examples 2 to 4. Furthermore, according to Examples 5 to 7, it is understood that the osmotic pressure ratio is decreased when the temperature-sensitive polymer has a mass percent concentration of 1-30 mass %,

As stated above, the water recovery method according to the present disclosure includes a first step of partitioning a feed solution and a DS having a higher osmotic pressure than that of the feed solution with a forward osmotic membrane to inflow water of the feed solution into the DS. A basic temperature-sensitive polymer and acidic gas are dissolved in the DS.

Accordingly, in the present disclosure, a large amount of acidic gas may be dissolved in the DS since a basic temperature-sensitive polymer is dissolved in the DS. Thereby, according to the present disclosure, the osmotic pressure of a draw solution may be easily increased.

In addition, according to the present disclosure, since the temperature-sensitive polymer and acidic gas may be removed from the DS mixed solution merely by heating and filtering the DS mixed solution, water may be easily recovered from the DS mixed solution. And in the present disclosure, since a large amount of acidic gas is dissolved in the DS, the mass percent concentration of the temperature-sensitive polymer may be reduced. Accordingly, the amount of solute that remains in water recovered from the DS mixed solution may be reduced, and the fouling of FO membrane may be simultaneously reduced.

In addition, as the temperature-sensitive polymer is precipitated and coagulated by heating, the solute of the DS is easily recovered and reused. As the solute does not include ammonia, water recovered from the DS mixed solution is safer.

Furthermore, in the present disclosure, the temperature-sensitive polymer includes a functional group represented by Chemical Formula 1, so the polymer has higher affinity for acidic gas. That is, a larger amount of acidic gas may be dissolved in the DS.

In addition, in the present disclosure, as the temperature-sensitive polymer is a polymer represented by Chemical Formula 2 or Chemical Formula 3, the polymer may be coagulated at a lower heating temperature. Accordingly, the energy consumption required for water recovery is further reduced.

In addition, as the acidic gas includes carbon dioxide, a larger amount of acidic gas may be dissolved in the DS, and simultaneously, water recovered from the DS mixed solution may be safer.

Furthermore, the water recovery method according to the present disclosure includes a second step of heating the DS mixed solution to precipitate the temperature-sensitive polymer in the DS mixed solution, and simultaneously, to remove acidic gas from the DS mixed solution, and a third step of separating the precipitated temperature-sensitive polymer from the DS mixed solution.

Thereby, in the present disclosure, the temperature-sensitive polymer and acidic gas may be easily removed from the DS mixed solution, and simultaneously, water having high purity may be recovered.

While various examples are described herein, it is to be understood that the present disclosure is not limited to the disclosed embodiments, but, on the contrary, is intended to cover various modifications and equivalent arrangements included within the spirit and scope of the appended claims.

For example, although the examples show that the temperature-sensitive polymers have structures of Chemical Formulae 1, 2, and 3, the present disclosure is not limited to the examples. In other words, the temperature-sensitive polymer may include any basic polymer. However, when water recovered from the DS mixed solution is provided for drinking, the temperature-sensitive polymer may be a polymer that is as safe as possible.

What is claimed is:

1. A water recovery method comprising:
partitioning a feed solution and a draw solution with a forward osmotic membrane, the feed solution including water, the draw solution including a basic temperature-sensitive polymer and an acidic gas dissolved therein, the draw solution having a higher osmotic pressure than the feed solution; and
inflowing the water from the feed solution into the draw solution via forward osmosis to form a mixed solution.

2. The water recovery method of claim 1, wherein the basic temperature-sensitive polymer comprises the following functional group represented by Chemical Formula 1:

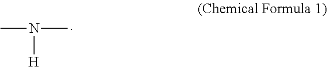

3. The water recovery method of claim 1, wherein the basic temperature-sensitive polymer is a polymer represented by Chemical Formula 2:

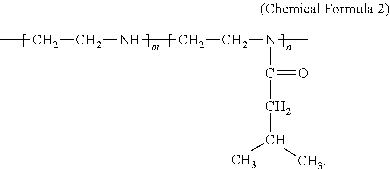

4. The water recovery method of claim 1, wherein the basic temperature-sensitive polymer is a polymer represented by Chemical Formula 3:

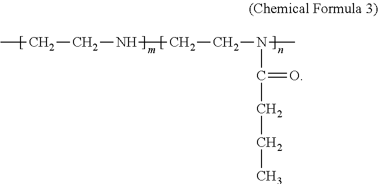

5. The water recovery method of claim 1, wherein the basic temperature-sensitive polymer has a weight average molecular weight of about 600 to about 70,000.

6. The water recovery method of claim 1, wherein the basic temperature-sensitive polymer is present at about 1 mass % to about 30 mass % based on a total mass of the draw solution.

7. The water recovery method of claim 1, wherein the acidic gas comprises carbon dioxide.

8. The water recovery method of claim 1, further comprising:
heating the mixed solution to form a precipitate of the basic temperature-sensitive polymer and to simultaneously remove the acidic gas from the mixed solution; and
separating the precipitate of the basic temperature-sensitive polymer from the mixed solution.

9. A draw solution for forward osmosis, comprising:
a basic temperature-sensitive polymer; and
an acidic gas dissolved in the draw solution.

10. The draw solution for forward osmosis of claim 9, wherein the basic temperature-sensitive polymer comprises the following functional group represented by Chemical Formula 1:

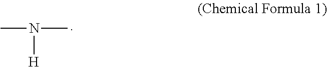

11. The draw solution for forward osmosis of claim 9, wherein the basic temperature-sensitive polymer is a polymer represented by Chemical Formula 2:

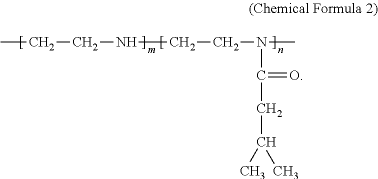

12. The draw solution for forward osmosis of claim 9, wherein the basic temperature-sensitive polymer is a polymer represented by Chemical Formula 3:

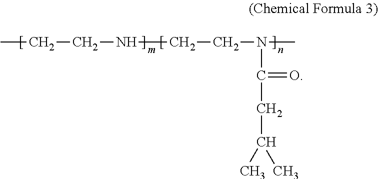

13. The draw solution for forward osmosis of claim 9, wherein the basic temperature-sensitive polymer has a weight average molecular weight of about 600 to about 70,000.

14. The draw solution for forward osmosis of claim 9, wherein the basic temperature-sensitive polymer is present at about 1 mass % to about 30 mass % based on a total mass of the draw solution.

15. The draw solution for forward osmosis of claim 9, wherein the acidic gas comprises carbon dioxide.
